(19) United States
(12) Patent Application Publication
(10) Pub. No.: US 2026/0371065 A1
(43) Pub. Date: Nov. 19, 2026

(54) METHOD AND SYSTEM FOR AUTOMATIC TELECOMMUNICATION SERVICE ACTIVATION OF ITEMS DISPENSED USING VENDING MACHINE

(71) Applicant: Verizon Patent and Licensing Inc., Basking Ridge, NJ (US)

(72) Inventors: Magesh Koteeswaran, Tamil Nadu (IN); Srinivasa R Kella, Princeton, NJ (US); Damodharan Sundararajan, Monroe, NJ (US); Arun P. Selvaraj, Irving, TX (US); Grady R. Milhon, Lincoln, NE (US); Senthil Muthusamy, Frisco, TX (US); Rajat Sharma, Southlake, TX (US); Hari Raju, Tamil Nadu (IN)

(21) Appl. No.: 19/206,308

(22) Filed: May 13, 2025

(51) Int. Cl. H04W 8/20; H04W 60/04; G06K 19/06; H04W 12/42; H04W 12/72

(52) U.S. Cl. CPC H04W 8/20; H04W 60/04; G06K 19/06037; H04W 12/42; H04W 12/72

(57) ABSTRACT

One or more computing devices, systems, and/or methods are provided. In an example, a selection of an item may be received via an interface panel of a vending machine. The item may be stored in a storage location of a storage system of the vending machine. An item retrieval process may be performed to collect the item from the storage location and/or transfer the item to a dispensing location. An image of the item may be captured, for example, using a camera coupled to a hopper and/or robotic arm used to perform the item retrieval process. One or more item identifiers associated with the item may be determined based upon the image. An activation process may be performed for the item based upon the one or more item identifiers.

### BACKGROUND

Vending machines may dispense products like electronics, snacks, beverages, and other goods when a user makes a selection and payment. They are commonly found in public places including stores, offices, malls, etc.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1A is a diagram illustrating an example system for providing activated items using a vending machine, according to some embodiments.

FIG. 1B is a diagram illustrating an example system for providing activated items using a vending machine, where an interface panel displays an item selection interface, a plan selection interface and/or a payment interface, according to some embodiments

FIG. 1C is a diagram illustrating an example system for providing activated items using a vending machine, where an interface panel displays an item selection interface, a hopper reaches a target position relative to a selected item, according to some embodiments.

FIG. 1D is a diagram illustrating an example system for providing activated items using a vending machine, where an image is processed to identify and/or decode a visual code associated with an item, according to some embodiments.

FIG. 1E is a diagram illustrating an example system for providing activated items using a vending machine, where an item is positioned at a dispensing location accessible to a user, according to some embodiments.

FIG. 2 is a flow chart illustrating an example method for determining interference metrics associated with a view and/or using the interference metrics to generate an interference map associated with the view, according to some embodiments.

FIG. 3 is a diagram illustrating an example system to facilitate one or more operations of a vending machine, according to some embodiments.

FIG. 4 is an illustration of a scenario featuring an example non- transitory machine readable medium, according to some embodiments.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion. The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of scenarios in which the disclosed subject matter may be utilized and/or implemented.

One or more systems and/or techniques are provided herein for automatically activating telecommunication service for items dispensed by a vending machine. The items may include Subscriber Identity Module (SIM) cards and/or SIM-equipped devices, for example, devices (e.g., phones, wearable devices, tablets, Internet of Things (loT) devices, etc.) equipped with SIM cards and/or embedded SIMs (eSIMs). In an example, a selection of an item and/or plan settings for a service plan may be received via an interface panel of the vending machine. An item retrieval process may be performed to collect the item from the storage location and/or transfer the item to a dispensing location. During the item retrieval process, an image of the item may be captured, for example, using a camera coupled to a hopper and/or robotic arm used to perform the item retrieval process. One or more item identifiers (e.g., International Mobile Equipment Identity (IMEI) and/or Integrated Circuit Card Identifier (ICCID)) associated with the item may be determined based upon the image. An automatic activation process may be performed for the item based upon the one or more item identifiers and/or the service plan.

In some embodiments, a portion of the activation process may be initiated and/or performed by the vending machine during the item retrieval process and/or prior to the item being retrieved from the dispensing location by a user. The activation process may include registering a device (e.g., a SIM-equipped device) of the item with a provider using the one or more item identifiers and/or associating the device with the service plan. Upon the item being retrieved by the user and the device being powered on, the device may connect (seamlessly, for example) to a wireless communication site (e.g., a base station, a gNB, an eNB, etc.) of the provider, which may promptly provide the device with telecommunication service according to the service plan, thereby providing for quicker service after purchasing the item and reduced manual effort (as the user may not have to manually perform an authentication process and/or one or more other acts of the activation process, for example).

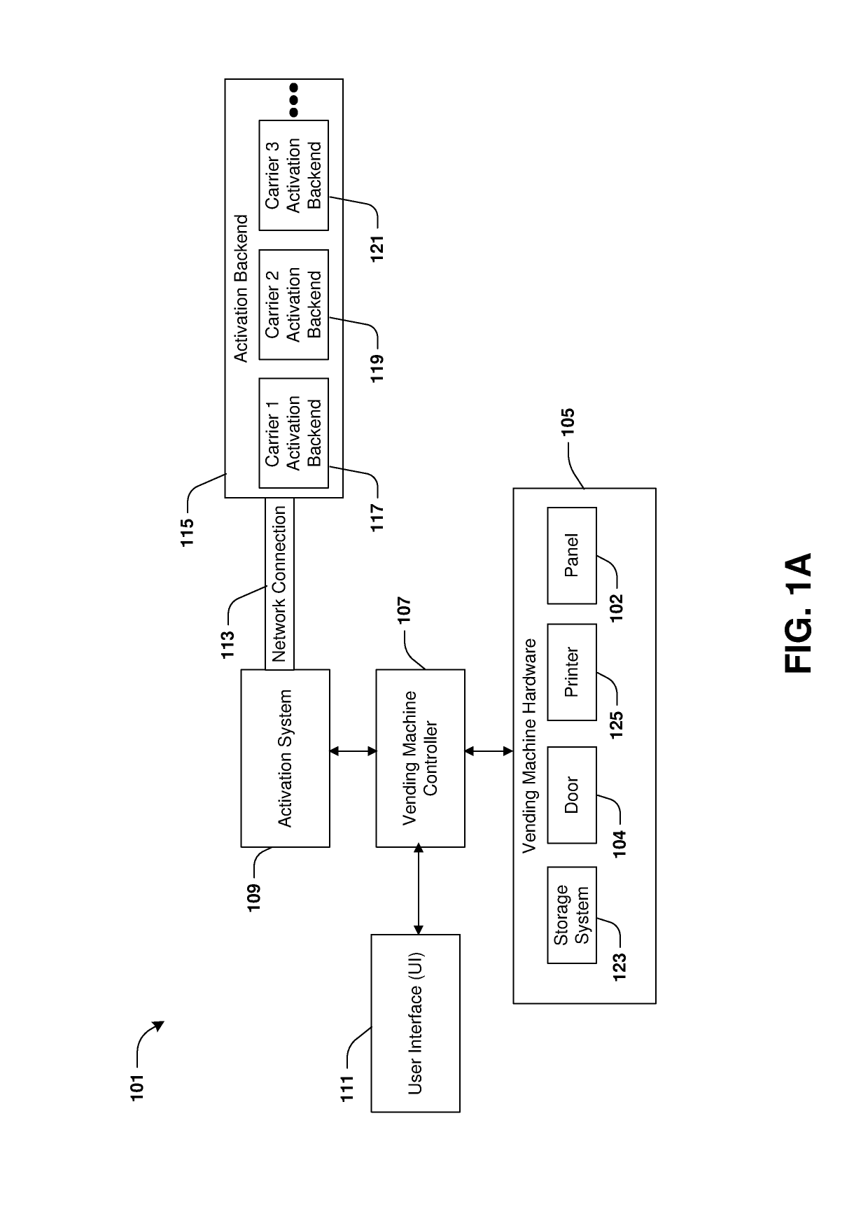

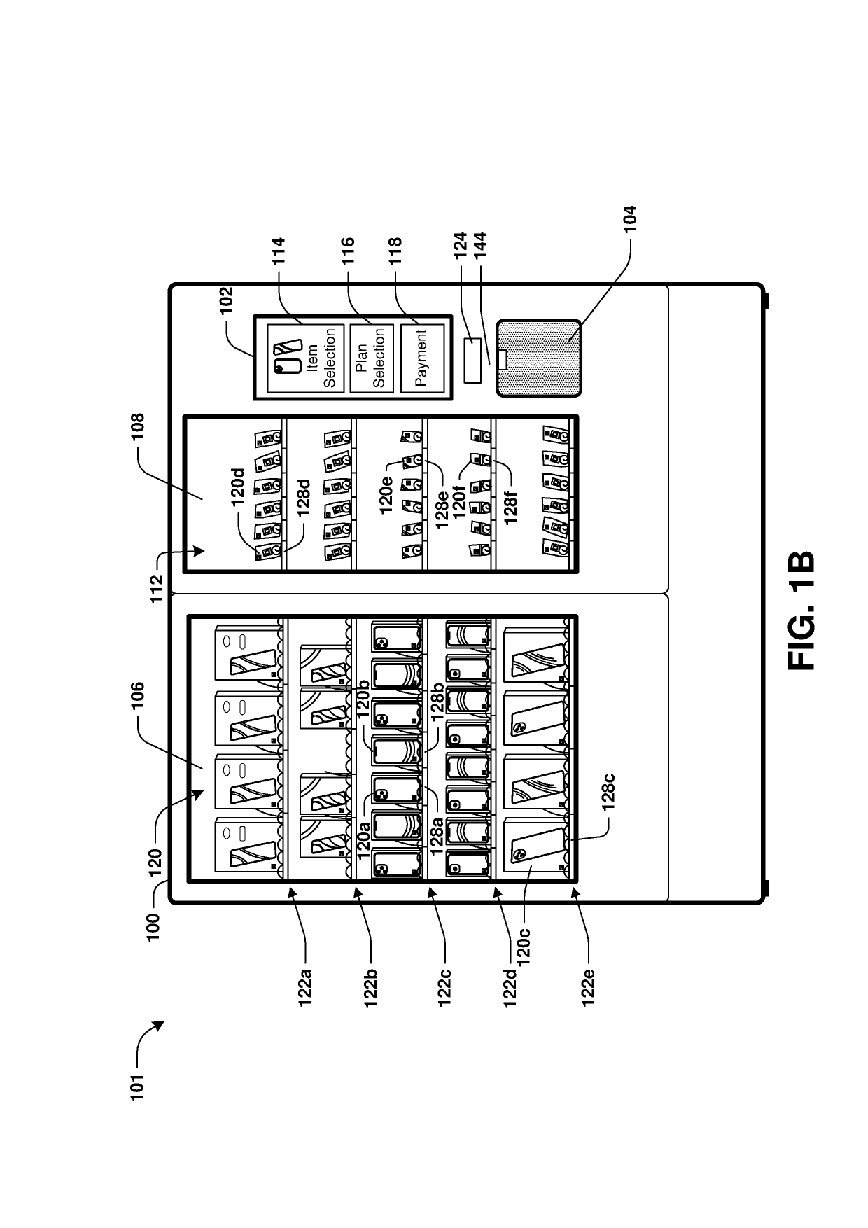

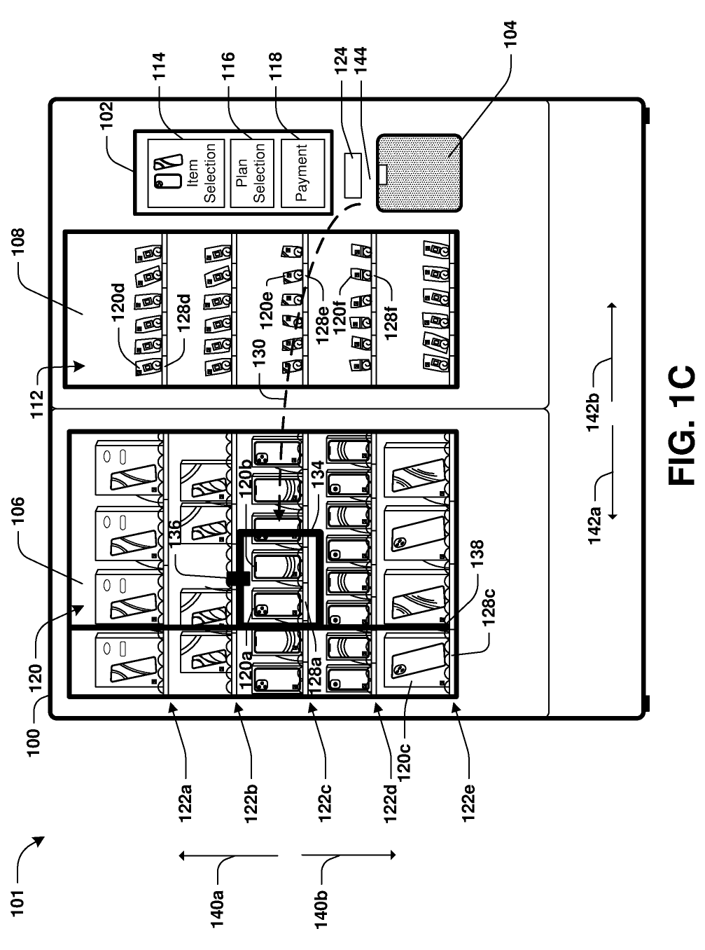

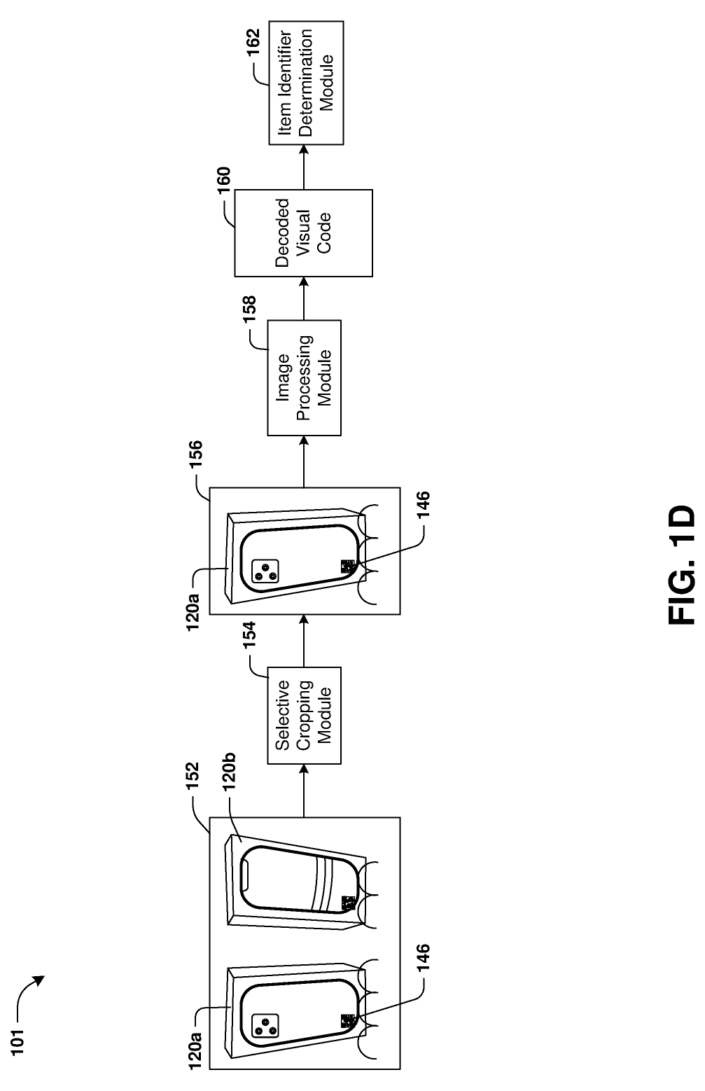

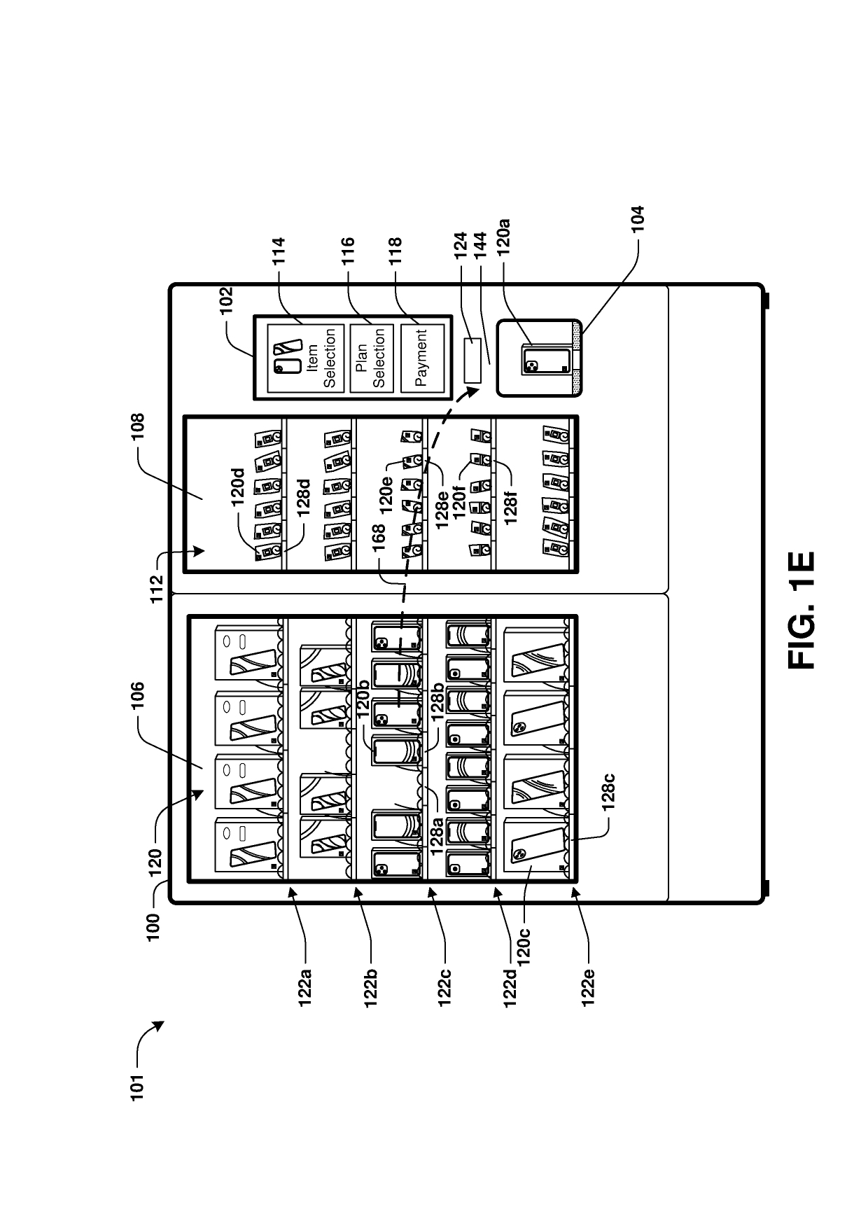

FIGS. 1A-1E illustrate examples of a system 101 for providing activated items using a vending machine 100. In some examples, an automatic activation system 109 for activating items dispensed using the vending machine 100 is provided. In some examples, the items may include SIM cards and/or SIM-equipped devices, for example, devices (e.g., phones, wearable devices, tablets, IoT devices, etc.) equipped with SIM cards and/or eSIMs. FIG. 1A illustrates components of the system 101 including theactivation system 109 for managing item activation, vending machine hardware 105 of the vending machine 100 and/or a vending machine controller 107 to control the vending machine hardware 105 and/or interact with the activation system 109.

In some examples, the vending machine hardware 105 may comprise a storage system 123, a dispensing slot door 104, a printer 125, an interface panel 102 and/or one or more other components. The vending machine controller 107 may provide a user interface 111 for display on the interface panel 102. The user interface 111 may be used for item selection, service plan selection, payment, and/or other actions associated with the vending machine 100. The activation system 109 may be connected to a backend system 115 via a network connection 113 (e.g., an encrypted Internet connection). The backend system 115 may comprise activation backend systems for a plurality of carriers (e.g., Mobile Network Operators (MNOs), Mobile Virtual Network Operators (MVNOs), etc.) such as an activation backend system 117 for activating items associated with a carrier "Carrier 1", a second activation backend system 119 for activating items associated with a second carrier "Carrier 2", a third activation backend system 121 for activating items associated with a third carrier "Carrier 3", etc.

FIG. 1B illustrates a front view of the vending machine 100. The vending machine 100 may comprise the interface panel 102 (e.g., a touchscreen panel), the dispensing slot door 104 to a dispensing slot, the storage system 123 with a plurality of storage locations for storing a plurality of items 120, and/or a hopper 134 for retrieving items selected and/or purchased by a user of the vending machine 100.

The vending machine 100 may comprise one or more viewing panels, such as a viewing panel 106 and/or a second viewing panel 108, which may provide a user with a view of some or all of the plurality of items 120. For example, the viewing panel 106 may comprise a transparent panel that provides visibility to a subset of storage locations of the plurality of storage locations and/or items stored in the subset of storage locations. The second viewing panel 108 may comprise a second transparent panel that provides visibility to a second subset of storage locations of the plurality of storage locations and/or items stored in the second subset of storage locations.

The storage system 123 may comprise racks on which items of the plurality of items are stored. The racks may be arranged in rows, such as rows 122a, 122b, 122c, 122d and/or 122e. Other quantities of rows of the storage system 123 of the vending machine 100 other than five rows (e.g., more or less than five rows) are within the scope of the present disclosure. In some examples, one or more of the racks may be fixed. In some examples, one or more of the racks may be adjustable (e.g., the storage system 123 may comprise one or more adjustment mechanisms to allow for modification of height, angle, spacing, etc. of a rack to accommodate different item sizes). The racks may be equipped with dividers, bins, and/or guiding rails to keep items properly aligned and/or prevent items from shifting during machine operation. In some examples, the storage system 123 may comprise gravity- fed sloped racks that allow items to slide forward for easy retrieval and/or a motorized push mechanism that advances an item of the plurality of items 120 to a dispensing position (and/or into the hopper 134 when the item is being collected, for example). In some examples, the storage system 123 may comprise a spring-loaded platform and/or an elevator-based mechanism that helps lift and/or position an item for retrieval (using the hopper 134, for example). In some examples, the storage system 123 may comprise a rotating carousel and/or conveyor-based system configured to transport items to an access point. In some examples, the storage system 123 may comprise sensors, weight-detection platforms and/or robotic arms to monitor an item for improper item positioning and/or reposition the item (using the robotic arm, for example) in response to determining that the item is improperly positioned, thereby facilitating smooth dispensing operations of the vending machine 100.

In some examples, the plurality of items 120 may comprise one or more item types. For example, the plurality of items 120 may comprise an item 120a and/or a second item 120b of an item type (e.g., a phone, such as smartphone and/or other type of phone), a third item 120c of a second item type (e.g., a tablet), a fourth item 120d of a third item type (e.g., a SIM card), a fifth item 120e of a fourth item type (e.g., a wearable device, such as asmartwatch, smart earphones, smart glasses, etc.), a sixth item 120f of a sixth item type (e.g., an loT device, such as a meter, a GPS tracking unit, etc.) and/or one or more other items of one or more other item types. The item 120a may be stored in a storage location over rack 128a, the second item 120b may be stored in a storage location over rack 128b, the third item 120c may be stored in a storage location over rack 128c, the fourth item 120d may be stored in a storage location over rack 128d, the fifth item 120e may be stored in a storage location over rack 128e, and/or the sixth item 120f may be stored in a storage location over rack 128f. In some examples, the plurality of items 120 may comprise device variants for one, some and/or all of the one or more item types. For example, the plurality of items 120 may comprise phone variants (e.g., phones with differences in storage capacity, brand, model, telecommunication service compatibility which may indicate one or more telecommunication service providers that are compatible with the phone, software packages, etc.), tablet variants, SIM card variants, wearable device variants and/or loT device variants.

In some examples, a user may use the interface panel 102 to select the item 120a from among the plurality of items 120. In some examples, the interface panel 102 may display an item selection interface 114 that allows the user to select the item 120a. For example, the item selection interface 114 may display a list (e.g., a scrollable list) of items of the plurality of items 120 that are available for purchase. In some examples, the item selection interface 114 may display a grid layout of item options (e.g., selectable graphical objects representative of items of the plurality of items 120), that may each comprise a brief item description and/or item price, enabling the user to visually browse and/or select the item 120a. In some examples, the item selection interface 114 may present categorized tabs and/or filters, allowing the user to narrow down choices based upon preferences such as item type, brand, price range, etc. In some examples, the item selection interface 114 may incorporate a search function, enabling the user to quickly locate desired items among the plurality of items 120. In some examples, the item selection interface 114 may provide real-time feedback on item availability, highlight promotions or discounts, and/or offer recommendationsbased upon browsing history of users of the vending machine 100 (and/or other vending machines) and/or popular item selections. In some examples, the vending machine controller 107 may receive (by the user tapping on a purchase button to purchase the item 120a, for example) a selection of the item 120a via the item selection interface 114.

In some examples, the interface panel 102 may display a plan selection interface 116 that allows the user to select a set of plan settings (e.g., a set of one or more plan settings) for a service plan. The user may use the plan selection interface 116 to submit plan information indicative of the service plan and/or the set of plan settings. For example, the set of plan settings may comprise a selection of a telecommunication service provider (e.g., a carrier to provide telecommunication services, such as an internet service, texting service, calling service, etc., in accordance with the service plan), a payment type (e.g., whether the service plan is prepaid or postpaid), a data allowance (e.g., a specified amount of mobile data per month, such as 5GB, 50GB, unlimited, etc.), a call allowance (e.g., a specified number of voice call minutes per month, such as 500 minutes, unlimited, etc.), a text allowance (e.g., a specified number of text messages per month, such as 1000 texts, unlimited, etc.), a hotspot or tethering allowance (e.g., whether mobile hotspot usage is permitted and/or any associated data limits), a network speed (e.g., a maximum data speed, and/or a reduced speed after a certain usage threshold), a network type (e.g., 5G, LTE, etc.), international features (e.g., availability of international calling, roaming, and/or data usage outside a primary coverage area), a streaming quality restriction (e.g., limitations on video streaming resolution such as 480p, 720p, 1080p, etc.), family plan options (e.g., whether multiple lines can be included under the service plan), additional services and/or add-ons (e.g., device insurance, priority customer support, bundled subscriptions, etc.), a contract length (e.g., whether the service plan requires a long-term commitment such as a 12- month contract or is offered on a month-to-month basis), etc

In some examples, the plan selection interface 116 may display a list or grid of plan options (e.g., selectable graphical objects representative of available service plans), each of the plan options comprising a summary ofone or more plan settings such as data allowance, call limits, text limits, pricing, etc. The plan selection interface 116 may allow the user to filter and/or sort the plan options based on desired criteria, such as selecting only prepaid or postpaid plans, choosing plans with unlimited data, or viewing plans that include international calling. The plan selection interface 116 may provide interactive elements such as dropdown menus, checkboxes, and/or radio buttons for customizing individual plan settings, such as selecting a preferred network type (e.g., 5G or LTE), choosing a hotspot data allowance, and/or adding optional services like device insurance and/or streaming subscriptions. In some examples, the plan selection interface 116 may display comparisons between plan options, recommendations based upon user preferences, and/or real-time updates on promotional offers or discounts. The plan selection interface 116 may display an estimated monthly cost generated based upon currently selected plan settings.

In some examples, the interface panel 102 may display a payment interface 118 that allows the user to submit a payment, for example, in compensation for purchasing the item 120a and/or performing an activation process (and/or one or more other services) associated with the service plan and/or the item 120a. The payment interface 118 may display various payment options available to the user, such as credit card, debit card, digital payment services (e.g., payment methods using mobile payment applications and/or digital wallets), cryptocurrency payment services, contactless Near- Field Communication (NFC) payments, visual code-based payments, prepaid balance deductions, cash, etc. In some examples, the payment interface 118 may present selectable inputs (e.g., buttons, icons, etc.) for each payment option (allowing the user to choose a preferred payment option, for example).

In some examples, in response to the user selecting a card-based payment method, the payment interface 118 may display instructions for using an integrated card reader 124 to execute the payment (by inserting a card into the integrated card reader 124, swiping the card using the integrated card reader 124, and/or tapping the card on the integrated card reader 124, for example). In some examples, in response to the user selecting a mobile payment method, the payment interface 118 may generate and/or display avisual code (e.g., Quick Response (QR) code and/or other type of code) for scanning using a mobile payment application to facilitate the payment. In some examples, in response to the user selecting a digital wallet payment method, the payment interface 118 may provide guidance for the user to make the payment using a digital wallet (and/or the payment may be automatically withdrawn from the digital wallet). In some examples, in response to the user selecting a cryptocurrency wallet payment method, the payment interface 118 may provide guidance for the user to make the payment using a cryptocurrency wallet (and/or the payment may be automatically withdrawn from the cryptocurrency wallet). In some examples, in response to the user selecting an NFC payment method, the payment interface 118 may prompt the user to hold a device (e.g., an NFC equipped device) near an NFC reader to execute the payment. In some examples, the payment interface 118 may prompt the user to log in to an account associated with a stored payment method. In some examples, the payment interface 118 may display real-time transaction details, such as the total amount due, itemized costs (e.g., item price, activation fees, taxes, etc.), applicable discounts and/or promotions, a remaining balance if a split payment performed, etc.

In some examples, in response to the user submitting the payment and/or receiving confirmation that the payment was successful, the payment interface 118 may display a confirmation message indicating successful payment processing, in some examples along with a selectable input for choosing to be provided with a digital receipt and/or printed receipt (which may be printed using the printer 125, for example).

In some examples, the interface panel 102 (and/or a speaker and/or microphone of the vending machine) may be used to present a conversational interface that may be implemented using a generative Artificial Intelligence(AI) model and/or that may engage in a conversation with the user (e.g., an audio conversation between the user and the generative Al model and/or a chat conversation with chat messages between the user and the generative Al model) that guides the user through one or more acts of selecting the item120a, selecting the service plan and/or the set of plan settings, and/or submitting the payment.

Embodiments are contemplated in which the item 120a is selected using a device different than the interface panel 102, such as using a client device (e.g., a smartphone, a tablet, a laptop, etc.) that may be accessible to the user or another user (e.g., a remote user that may submit the order remotely from a different location, such as a different area, city or country, using the client device). For example, the automatic activation system 109 may present an order submission interface on the device. For example, the order submission interface may be presented by a mobile application on the device and/or a webpage displayed by a browser of the device. In some examples, the order submission interface may comprise a conversational interface that may be implemented using the generative Al model and/or that may guide a user through one or more acts of selecting the item 120a, selecting the service plan and/or the set of plan settings, and/or submitting the payment. In some examples, the order submission interface may comprise a second item selection interface (with one or more of the features and/or functionalities of the item selection interface 114, for example), a second plan selection interface (with one or more of the features and/or functionalities of the plan selection interface 116, for example), and/or a second payment interface (with one or more of the features and/or functionalities of the computing device 302 payment interface 118, for example). In some examples, an order (e.g., a phone order) with the selection of the item 120a, the selection of the service plan and/or the set of plan settings, and/or the payment may be submitted via a call (e.g., a voice call, a video call, etc.) and/or chat with a customer service representative.

In some examples, in response to receiving the selection of the item 120a, the plan information indicative of the service plan and/or the payment (and/or confirmation that the payment was successful), the vending machine 100 may perform an item retrieval process to collect the item 120a from the storage location over the rack 128a and/or transfer the item 120a to a dispensing location (in the dispensing slot, for example). In some examples, the item retrieval process may be performed using a hopper 134, which maybe attached to a post 138 (e.g., a vertical post). The hopper 134 may be moveably coupled to the post 138. In some examples, a driving mechanism (e.g., a motor, a pneumatic actuator, a belt and/or pulley system, etc.) may move the hopper 134 vertically (along directions 140a and/or 140b, for example) along the post 138 to move the hopper 134 to a desired vertical position relative to the item 120a. In some examples, a second driving mechanism (e.g., a motor, a pneumatic actuator, a belt and/or pulley system, etc.) may move the post 138 horizontally (along directions 142aand/or 142b, for example) to move the hopper 134 to a desired horizontal position relative to the item 120a. FIG. 1C illustrates the hopper 134 having the desired vertical position and the desired horizontal position, in accordance with some embodiments. In some examples, the item retrieval process comprises using the driving mechanism and/or the second driving mechanism to move the hopper 134 along a path 130 from a hopper position (e.g., behind a panel 144 of the vending machine 100) to a second hopper position (e.g., the position of the hopper 134 in front of the item 120a shown in FIG. 1C)

In some examples, the hopper 134 may be guided to the second hopper position based upon the storage location (of the plurality of storage locations) in which the item 120a is stored in the storage system 123 of the vending machine 100. For example, the storage location may be indicative of a row and/or column of the item 120a, and/or may be determined based upon a planogram and/or other data structure that maps items of the plurality of items 120 to storage locations of the plurality of storage locations of the storage system 123. In some examples, the planogram (and/or the other data structure) may be stored in an inventory management database that keeps track of which items are at which storage locations for one or more vending machines comprising the vending machine 100. In an example scenario in which the item 120a is located three rows down from the top (e.g., row C) and three columns in from the left (e.g., column C), the storage location where the item 120a is located may be represented as "C, 3" in the planogram and/or the inventory management database. The vending machine controller 107 may translate the storage location (e.g., "C, 3") into a movement path (e.g., the path 130) and/or a target hopper position (e.g., the second hopper position) for the hopper 134 and/or move the hopper 134 (using the driving mechanism and/or the second driving mechanism, for example) to the second hopper position (for collection of the item 120a) based upon the movement path and/or the target hopper position associated with the storage location.

In some examples, items of the plurality of items 120 may be labeled with visual codes (e.g., QR codes and/or other types of codes) that each may identify a corresponding item and/or may be used to determine one or more item identifiers and/or other information associated with the corresponding item, such as storage capacity, brand, model, telecommunication service compatibility, etc. In some examples, the vending machine 100 may comprise a camera 136 to scan visual codes of the plurality of items 120. In some examples, the camera 136 may face the items (and/or racks of the storage system 123 and/or a back panel of the vending machine 100) such that an image captured by the camera 136 has a view of one or more items stored in the vending machine 100. In some examples, the camera 136 may be coupled to a moveable component, such as the hopper 134, that moves the camera 136 throughout the vending machine 100 such that the camera 136 may capture images with views of various storage locations of the plurality of storage locations (and/or various items stored throughout the various storage locations). For example, the moveable component (e.g., the hopper 134) may move the camera 136 to a target camera position relative to the item 120a (e.g., a position of the camera 136 where the camera 136 has a view of at least a portion of the item 120a).

In some examples, the camera 136 may capture an image 152 (shown in FIG. 1D) of the item 120a. For example, the vending machine controller 107 may activate the camera 136 and/or trigger the camera 136 to capture the image 152 in response to determining that the camera 136 is at the target camera position relative to the item 120a. In some examples, the image 152 may be captured during the item retrieval process. For example, the image 152 may be captured when the hopper 134 is at the target hopper position (e.g., the second hopper position shown in FIG. 1C) relative to the item 120a. In some examples, the vending machine controller 107 may determine that the camera 136 is at the target camera position based upon adetermination that the hopper 134 is at the target hopper position. For example, the camera 136 may be positioned relative to the hopper 134 such that the camera 136 has a view of the item 120a when the hopper 134 reaches the target hopper position. In some examples, the hopper 134 is mounted to the hopper 134 using a fixed angle mount. In some examples, the hopper 134 is mounted to the hopper 134 using an adjustable angle mount that adjusts a position of the camera 136 relative to the hopper 134 (to optimize visibility of a target item such as the item 120a, for example).

In some examples, in response to capturing the image 152 using the camera 136, one or more operations may be performed (e.g., by the automatic activation system 109, for example) to identify a visual code 146 (shown in FIG. 1D) associated with the item 120a in the image 152 and/or decode the visual code 146. In some examples, the visual code 146 may comprise a QR code, a barcode, a set of numbers, symbols and/or letters, etc. labeled and/or printed on packaging of the item 120a. FIG. 1D illustrates use of the image 152 to determine the decoded visual code 160, which may be used to determine one or more item identifiers associated with the item 120a. An image processing module 158 (e.g., in the automatic activation system 109) may analyze the image (e.g., using one or more Al image processing techniques for example) to identify the visual code 146 in the image, and/or to decode the visual code 146 to generate a decoded visual code 160. In some examples, the decoded visual code 160 may be provided to an item identifier determination module 162 (e.g., in the automatic activation system 109).

In some examples, the image 152 has a view of the item 120a and the second item 120b (e.g., the field of view of the camera 136 is such that the second item 120b is visible when the camera is positioned for imaging item 120a). In some examples, a selective cropping module 154 of the automatic activation system 109 may be used to identify a target item (e.g., the item 120a) among multiple items in the image 152 and/or crop the image 152 to generate a cropped image 156 excluding at least a portion of the second item 120b. The selective cropping module 154 may identify the target item based upon a position of the target item relative to a field of view (FoV) ofthe image 152. For example, the selective cropping module 154 may select an item closest to a center (or other predefined location) of the FoV of the image 152 as the target item. In some examples, the selective cropping module 154 may perform a verification process to verify that the identified item matches one or more expected characteristics of the target item, such as predefined shape, predefined size, and/or visual code presence, before finalizing the selection of the item 120a as the target item and/or performing the cropping operation to generate the cropped image 156 with the target item (e.g., the item 120a). The cropped image may be provided to image processing module 158 to identify the visual code 146 in the cropped image 156, and/or to decode the visual code 146 to generate a decoded visual code 160.

The item identifier determination module 162 may determine the one or more item identifiers based upon the decoded visual code 146. In some examples, the one or more item identifiers may comprise an International Mobile Equipment Identity (IMEI) associated with the item 120a, an Integrated Circuit Card Identifier (ICCID) and/or Embedded Universal Integrated Circuit Card (eUICC) Identifier (EID) associated with the item 120a, a stock-keeping unit (SKU) associated with the item 120a, and/or a vendor identifier associated with the item 120a. In some examples, in response to determining the one or more item identifiers, the item identifier determination module 162 may cross-reference the one or more item identifiers with one or more identifiers of a database (e.g., the database may be stored in the vending machine controller 107, the automatic activation system 109 and/or the backend system 115) to verify the one or more item identifiers are associated with the item 120a.

In some examples, the item identifier determination module 162 may use the QR code to determine an item identifier (e.g., the IMEI) of the one or more item identifiers (e.g., the item identifier determination module 162 may validate the QR code to determine the IMEI) and/or may use the item identifier to determine a second item identifier (e.g., the ICCID and/or EID) of the one or more item identifiers. For example, the item identifier determination module 162 may transmit a request to the backend system 115(e.g., using an Application Programming Interface (API) call requesting the ICCID and/or EID) that includes the item identifier (e.g., the IMEI). The backend system 115 may then respond by providing the item identifier determination module 162 with the second item identifier (e.g., the backend system 115 may determine that the ICCID and/or EID is paired with the IMEI indicated by the identifier request, for example). In a scenario in which the telecommunication service provider is the carrier "Carrier 1", the request may be submitted to the activation backend system 117, which may provide the item identifier determination module 162 with the second item identifier.

In some examples, in response to determining the one or more item identifiers (and/or cross-referencing the one or more item identifiers with the database to verify the one or more item identifiers are associated with the item 120a), the automatic activation system 109 may perform an activation process using the one or more item identifiers. In some examples, the activation process may comprise submitting an activation request (e.g., an API call) indicative of one or more item identifiers (e.g., the IMEI and/or the ICCID and/or EID) of the one or more item identifiers to the activation backend system 117 associated with the telecommunication service provider associated with the service plan. The activation request may be indicative of the service plan and/or the set of plan settings associated with the service plan. In some examples, in response to receiving the activation request, the activation backend system 117 may register the item 120a with the telecommunication service provider using the one or more item identifiers and/or may associate with the item 120a with the service plan.

In some examples, the item 120a may comprise a device (e.g., a phone, a tablet, a wearable device, an loT device, etc.) equipped with a SIM card and/or an eSIM. In some examples, an item identifier (e.g., the ICCID and/or EID) of the one or more item identifiers may identify the SIM card and/or the eSIM (e.g., the ICCID may identify the SIM card and/or the EID may identify the eSIM). In some examples, the device and/or the SIM card and/or the eSIM may be provided with telecommunication services (e.g., internet service, texting service, calling service, etc.) in accordance with the service plan in response to performing the activation process (e.g., in response to submitting the IMEI and/or the ICCID and/or EID of the one or more item identifiers to the activation backend system 117 associated with the telecommunication service provider). The IMEI may be used by the telecommunication service provider to identify the device and/or the ICCID (and/or EID) may be used by the telecommunication service provider to identify the SIM card and/or the eSIM. The activation backend system 117 may register the item 120a (and/or the device of the item 120a), the SIM card and/or the eSIM with the telecommunication service provider using the one or more item identifiers, such as by providing one or more of the one or more item identifiers (e.g., the IMEI, the ICCID and/or EID) to a provider registry of the telecommunication service provider. The activation backend system 117 may associate the item 120a (and/or the device of the item 120a), the SIM card and/or the eSIM (and/or an item identifier of the one or more item identifiers) with the service plan, such as by providing the plan information to the provider registry. The provider registry may keep track of devices, SIM cards and/or eSIMs with active subscriptions to telecommunication service of the telecommunication service provider.

In some examples, the activation process may comprise establishing a service account for the user (and/or adding a line corresponding to the service plan to an existing service account associated with the user). In some examples, the activation process may comprise authenticating the user (e.g., verifying that the identity of the user) and/or authorizing the one or more item identifiers (e.g., verifying that the one or more item identifiers are not blacklisted and/or are allowed to access networks of the telecommunication service provider). In some examples, the activation process may further include one or more of: associating a profile stored in the SIM/eSIM with the user account, associating a profile stored in the activation backend system 117 with the user account and the SIM/eSIM, and/or associating the user account with the one or more item identifiers associated with the user. In some examples, the device may obtain telecommunications services after being powered on (by the user, for example) through communications with the activation backend system 117 using the profile associated with the device and user during the activationprocess. In some examples, the profile is downloaded to the device from the activation backend system 117.

In some examples, the item retrieval process may comprise transferring (and/or unloading) the item 120a into an item holding chamber (e.g., an item container and/or basket) defined by the hopper 134 (when and/or after the hopper 134 is at the second hopper position, for example). In some examples, the vending machine 100 may comprise a mechanical component that facilitates transfer of the item 120a into the item holding chamber (e.g., a rotating coil, a helix, a robotic arm, a gripping mechanism, a pusher mechanism, etc., or some combination thereof). In some examples, in response to transferring the item 120a into the item holding chamber of the hopper 134, the hopper 134 may be moved (using the driving mechanism and/or the second driving mechanism, for example) along a second path 168 (shown in FIG. 1E) from the second hopper position (e.g., the position of the hopper 134 in front of the item 120a shown in FIG. 1C) to an item dispensing position (e.g., behind the panel 144 of the vending machine 100) relative to the dispensing slot. In some examples, in response to the hopper 134 reaching the item dispensing position, the item 120a may be transferred from the hopper 134 (and/or from the item holding chamber defined by the hopper 134) to a dispensing location (in the dispensing slot, for example). In some examples, the item 120a is accessible to the user when the item 120a reaches the dispensing location. In some examples, the vending machine 100 may comprise the dispensing slot door 104 (and/or other component) that may obstruct user access to the dispensing location. In some examples, the vending machine controller 107 may engage the dispensing slot door 104 (by opening the dispensing slot door 104, for example) to allow access to the item 120a.

FIG. 1E illustrates the vending machine 100 after the dispensing slot door 104 is engaged to provide user access to the item 120a. In some examples, the user may retrieve the item 120a from the vending machine 100. In some examples, the vending machine 100 may comprise one or more sensors to confirm that the item 120a was retrieved from the dispensing location. In some examples, the vending machine controller 107 may closethe dispensing slot door 104 in response to confirming that the item 120a was retrieved from the dispensing location.

In some examples, at least a portion of the activation process (to activate the device with the service plan, for example) may be performed (and/or started and/or completed) during the item retrieval process (and/or prior to the item 120a reaching the dispensing location and/or prior to the dispensing slot door 104 being engaged to allow access to the item 120a). In some examples, the device may be activated with the service plan before or upon the device being powered on. For example, in response to the device being powered on, the device may connect to a wireless communication site (e.g., a base station, a gNB, an eNB, etc.) which may recognize one or more item identifiers (e.g., the IMEI associated with the device, the ICCID and/or EID associated with the SIM card and/or the eSIM, etc.) and/or provide the device with one or more telecommunication services based upon the service plan. Thus, upon the device being powered on (in response to pushing a power button, for example), the user may make outgoing calls, receive incoming calls, make outgoing texts, receiving incoming texts, connect to internet service, and/or perform other actions using telecommunication service provided by one or more wireless communication sites (in accordance with the service plan, for example), without the need for the user to provide identification information or other credentials.

In some examples, the item 120a may comprise a (standalone) SIM card (e.g., the item 120a may be of the third item type) and/or the activation process may be performed using an identifier (e.g., an ICCID) associated with the SIM card and/or a second identifier (e.g., an IMEI) associated with a separate device (e.g., a device, such as a phone, a tablet, a wearable device, an loT device, etc.), that the user already has possession of and/or wants to use with the SIM card. In some examples, the second identifier may be received via the plan selection interface 116 (and/or the second plan selection interface). For example, the plan selection interface 116 may prompt the user to enter the second identifier (in order to complete the activation process, for example). In some examples, the automatic activation system 109 may submit the identifier (e.g., the ICCID) associated with the SIM card and/or thesecond identifier (e.g., the IMEI) associated with the separate device (and/or an indication of the service plan) to the activation backend system 117 associated with the telecommunication service provider associated with the service plan. In some examples, the activation backend system 117 may associate the SIM card and/or the separate device with the service plan based upon the identifier associated with the SIM card, the second identifier associated with the separate device, and/or the service plan.

In some examples, the separate device and/or the SIM card may be activated with the service plan before and/or upon the separate device being powered while the SIM card is connected to a SIM card reader of the separate device (and/or before and/or upon the SIM card being connected to and/or inserted into the separate device). For example, in response to the separate device being powered on and/or the SIM card being connected to and/or inserted into the separate device, the separate device may connect to a wireless communication site (e.g., a base station, a gNB, an eNB, etc.) which may recognize one or more item identifiers (e.g., the identifier associated with the SIM card, the second identifier associated with the separate device, etc.) and/or provide the separate device with one or more telecommunication services based upon the service plan. Thus, upon the separate device being powered on and/or the SIM card being connected to and/or inserted into the separate device, the user may make outgoing calls, receive incoming calls, make outgoing texts, receiving incoming texts, connect to internet service, and/or perform other actions using telecommunication service provided by one or more wireless communication sites (in accordance with the service plan, for example) without the need to provide user identification or credentials.

In some examples, the vending machine 100 may comprise a robotic arm (as an alternative to or in addition to) the hopper 134. Alternatively and/or additionally, the hopper 134 may be coupled to the robotic arm. The robotic arm may be configured to perform the item retrieval process. For example, the robotic arm may collect the item 120a from the storage location and/or transfer the item 120a to the dispensing location (in the dispensing slot, for example). In some examples, the camera 136 iscoupled to the robotic arm and/or captures the image 152 while the robotic arm is positioned at a target position relative to the item 120a.

In some examples, the automatic activation system 109 may maintain and/or update an item identifier data structure indicative of item identifier entries for some or all items of the plurality of items 120. For example, the item identifier data structure may comprise an item identifier entry associated with the item 120a, a second item identifier entry associated with the second item 120b, etc. The item identifier entry may be indicative of one or more of the one or more item identifiers determined by the item identifier determination module 162. In some examples, the item identifier entry may comprise data that is usable (by the automatic activation system 109 and/or the vending machine controller 107, for example) to determine the one or more item identifiers. In some examples, the item identifier entry may be indicative of the storage location of the item 120a. In some examples, in response to an item at a storage location being purchased and/or dispensed and a different item (that was behind the item, for example) moving into and/or occupying the storage location, the item identifier data structure may be updated to indicate that the different item is at the storage location. In some examples, the automatic activation system 109 may use the one or more item identifiers that were determined based upon the item identifier data structure to perform the activation process for the item 120a, which may thereby facilitate automatic item activation for the item 120a without requiring the camera 136 to capture the image 152 and/or scan the visual code 146. In this manner, the vending machine 100 may activate and provide the item 120a to the user without having and/or using the camera 136 and/or without the items having visual codes, for example.

In some examples, the system 101 may comprise an inventory management system to provide inventory management services for the vending machine 100, such as services for managing, modifying and/or keeping track of inventories and/or other parameters associated with the vending machine 100. The inventory management system may be used to perform a calibration process to determine inventory statuses associated with storage locations of the vending machine 100 and/or generate an inventoryprofile associated with the vending machine 100. A notification system may send alerts (e.g., out-of-stock alerts, item misplacement alerts, low-inventory alerts, etc.) to one or more vendor agents in response to the calibration process detecting an inventory issue. The calibration process may be performed using the visual codes (e.g., QR codes and/or other types of codes) of the plurality of items 120. The calibration process may be performed using one or more of the techniques provided in U.S. Patent Application entitled "METHOD AND SYSTEM FOR AUTOMATIC VENDING MACHINE INVENTORY MANAGEMENT", having attorney docket number 20240549, naming Magesh Koteeswaran, Srinivasa Rao Kella, Damodharan Sundararajan, Arun Prabhu Selvaraj, Grady R Milhon, Senthil Muthasamy, and Rajat Sharma as inventors, which is incorporated by reference herein in its entirety.

In some examples, the automatic activation system 109 and/or the vending machine controller 107 may be implemented by a computer of the vending machine 100 and/or a second computer (e.g., a server) connected to the computer via a network (e.g., the Internet). The computer and/or the second computer, for example, may run an application that displays the item selection interface 114, the plan selection interface 116 and/or the payment interface 118 on the interface panel 102 on the interface panel 102.

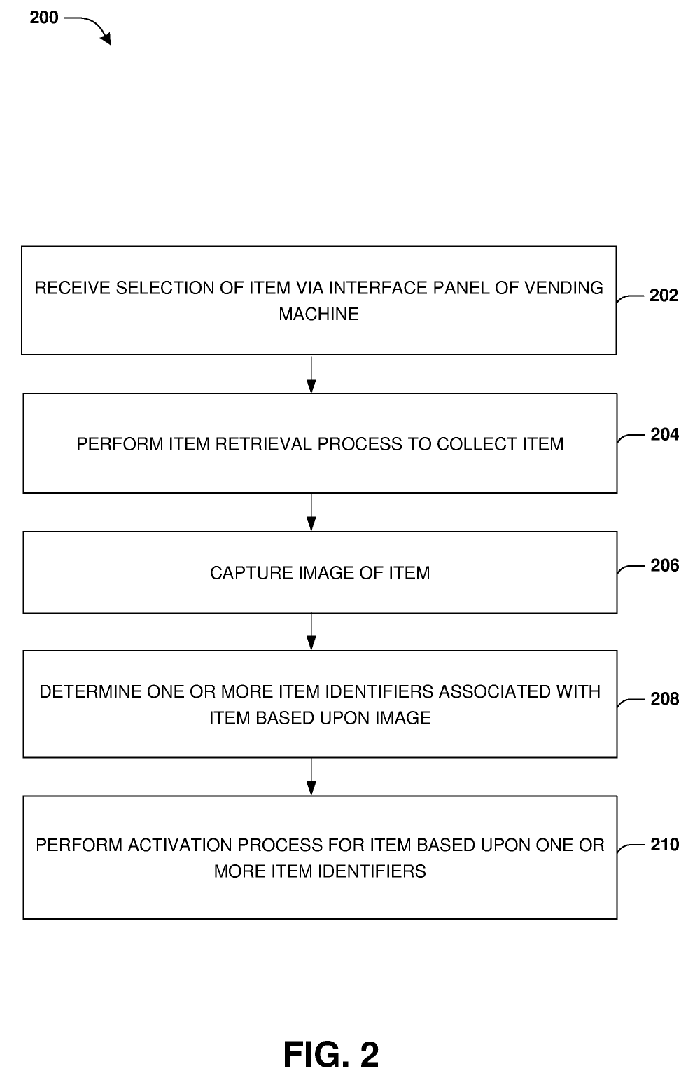

An embodiment of providing activated items using a vending machine (e.g., the vending machine 100) is illustrated by an exemplary method 200 of FIG. 2. At 202, a selection of an item (e.g., the item 120a) may be received via an interface panel (e.g., the interface panel 102) of the vending machine. The item may be stored in a storage location of a storage system 123 of the vending machine. At 204, an item retrieval process may be performed to collect the item from the storage location and/or transfer the item to a dispensing location (where the item is accessible to a user, for example). For example, the item retrieval process may be performed using a hopper (e.g., the hopper 134) and/or a robotic arm. At 206, an image (e.g., the image 152) of the item may be captured. For example, the image may be captured (during the item retrieval process, for example) using a camera coupled to the hopper and/or the robotic arm. At 208, one or more item identifiers (e.g., theone or more item identifiers determined by the item identifier determination module 162) associated with the item may be determined based upon the image. At 210, an activation process may be performed for the item based upon the one or more item identifiers.

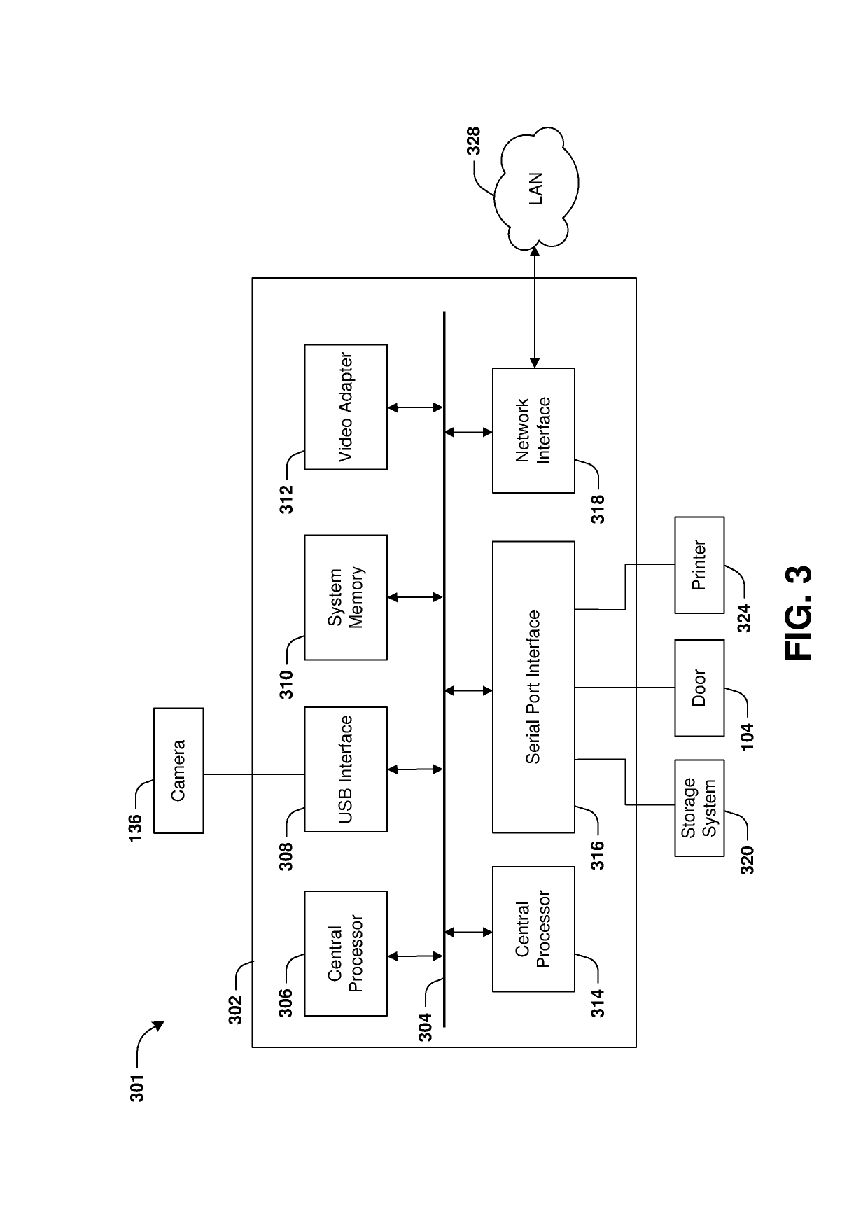

FIG. 3 illustrates a system 301 used to facilitate one or more operations of the vending machine 100, such as item and/or plan selection, payment processing, service activation for an item, and/or product dispensing. In some examples, the system 301 may comprise a computing device 302 (e.g., the vending machine controller 107 and/or the computer of the vending machine 100) that may coordinate and/or execute one or more operations of the vending machine 100. The computing device 302 may comprise a central processor 306 and/or a second central processor 314, which may be responsible for executing software instructions, managing input and output operations, overseeing overall functionality of the computing device 302, etc. In some examples, the second central processor 314 may be utilized for handling specialized tasks independently from the central processor 306. For example, the central processor 306 may be used for general computing functions, while the second central processor 314 may be used for handling real-time operations related to controlling one or more components of the vending machine 100, such as the storage system 123, the dispensing slot door 104 of the vending machine 100, the interface panel 102, and/or the printer 125 of the vending machine 100 (e.g., the printer 125 may be used for printing receipts and/or other documents). In some examples, having multiple central processors in the same computing device 302 may enhance performance by distributing processing tasks, ensuring that functions such as user interactions and/or payment processing do not interfere with hardware control operations, for example. Alternatively and/or additionally, computational tasks may be divided between the central processor 306 and the second central processor 314 may enhance system efficiency, such as by allowing different operations to be processed in parallel, thereby reducing delays and/or improving overall performance associated with the vending machine 100.

In some examples, the system 301 may comprise system memory 310 that may store one or more applications and/or instructions executed by the central processor 306 and/or the second central processor 314 to control functionality of the vending machine 100. The system memory 310 may store one or more configuration settings, such as network parameters, device identifiers, and/or communication protocols used to interface with external systems, such as payment processors, inventory management databases (e.g., the inventory management database), and/or item activation services. In some examples, the system memory 310 may store item inventory data, including details about the plurality of items 120 available for selection and/or purchase, such as item descriptions, prices, availability status, and/or associated service plans. In some examples, the system memory 310 may store user interaction data, such as selection history, payment transactions, and/or preferences, which may be used to personalize the item selection interface 114 and/or the plan selection interface 116 for the user. The system memory 310 may temporarily store data related to in-progress transactions, network communications, and/or real-time processing tasks performed by the vending machine 100, and/or may delete the temporarily stored data in response to determining that the temporarily stored data is no longer needed for the in-progress transactions, network communications, and/or real-time processing tasks.

In some examples, the system 301 may comprise a bus 304, which may interconnect various components within the computing device 302 to facilitate data transfer between the components, such as the central processor 306, the second central processor 314, a USB interface 308, the system memory 310, a video adapter 312, a network interface 318, and/or a serial port interface 316. In some examples, the computing device 302 may be configured to control the camera 136. The camera 136 may be connected to the bus 304 and/or the computing device 302 via the USB interface 308 and/or one or more other interface types. In some examples, the network interface 318 of the system 301 may provide a connection between the computing device 302 and a Local Area Network (LAN) 328 to facilitate communication between the computing device 302 and external networksand/or cloud-based services. In some examples, the serial port interface 316 (and/or one or more other interface types) may provide a connection between the computing device 302 and the storage system 123, the dispensing slot door 104, and/or the printer 125.

Implementation of at least some of the disclosed subject matter may lead to benefits including, but not limited to, reduced (and/or zero) manual effort in comparison with some vending machine systems that provide SIM cards and/or SIM-equipped devices that are not activated and/or authenticated.

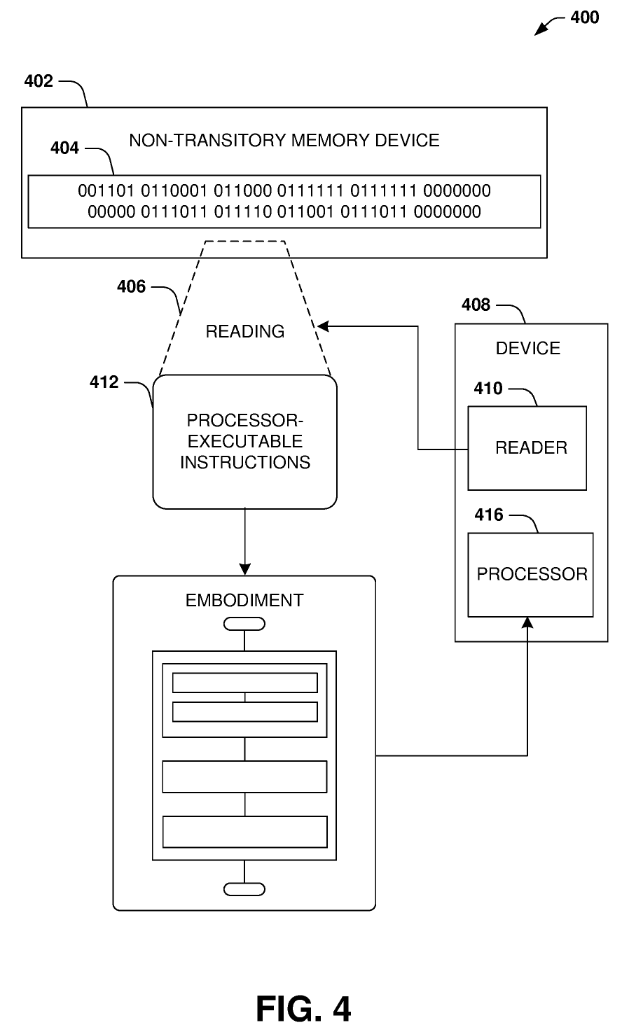

FIG. 4 is an illustration of a scenario 400 involving an example non- transitory machine readable medium 402. The non-transitory machine readable medium 402 may comprise processor-executable instructions 412 that when executed by a processor 416 cause performance (e.g., by the processor 416) of at least some of the provisions herein. The non-transitory machine readable medium 402 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 402 stores computer-readable data 404 that, when subjected to reading 406 by a reader 410 of a device 408 (e.g., a read head of a hard disk drive, or a read operation invoked on a solid-state storage device), express the processor-executable instructions 412. In some embodiments, the processor-executable instructions 412, when executed cause performance of operations, such as at least some of the example method 200 of FIG. 2, for example. In some embodiments, the processor-executable instructions 412 are configured to cause implementation of a system, such as at least some of the example system 101 of FIGS. 1A-1E and/or at least some of the example system 301 of FIG. 3, for example.

To the extent the aforementioned implementations collect, store, or employ personal information of individuals, groups or other entities, it should be understood that such information shall be used in accordance with allapplicable laws concerning protection of personal information. Additionally, the collection, storage, and use of such information can be subject to consent of the individual to such activity, for example, through well known "opt-in" or "opt-out" processes as can be appropriate for the situation and type of information. Storage and use of personal information can be in an appropriately secure manner reflective of the type of information, for example, through various access control, encryption and anonymization techniques for particularly sensitive information.

As used in this application, "component," "module," "system", "interface", and/or the like are generally intended to refer to a computer- related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, "first," "second," and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, "example" is used herein to mean serving as an example, instance, illustration, etc., and not necessarily as advantageous. As used herein, "or" is intended to mean an inclusive "or" rather than an exclusive "or". In addition, "a" and "an" as used in this application are generally be construed to mean "one or more" unless specified otherwise or clear from context to be directed to a singular form. Also, at least one of A and B and/or the like generally means A or B or both A and B. Furthermore, to the extent that "includes", "having", "has", "with", and/or variants thereof are used in either the detailed description or the claims, such terms are intended to be inclusive in a manner similar to the term "comprising".

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term "article of manufacture" as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some and/or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method comprising:
receiving a selection of an item via an interface panel of a vending machine, wherein:
the vending machine comprises a storage system with a plurality of storage locations; and
the item is stored in a storage location of the plurality of storage locations;
performing an item retrieval process to collect the item from the storage location and transfer the item to a dispensing location;
capturing an image of the item;
determining one or more item identifiers associated with the item based upon the image; and
performing an activation process for the item based upon the one or more item identifiers.

2. The method of claim 1, comprising:
analyzing the image to identify a visual code on the item; and
determining the one or more item identifiers based upon the visual code.

3. The method of claim 2, wherein the one or more item identifiers comprise at least one of:
an International Mobile Equipment Identity (IMEI) associated with the item;
an Integrated Circuit Card Identifier (ICCID) associated with the item;
an Embedded Universal Integrated Circuit Card (eUICC) Identifier (EID) associated with the item;
a stock-keeping unit (SKU) associated with the item; or
a vendor identifier associated with the item.

4. The method of claim 1, wherein performing the activation process comprises:
registering a device of the item with a telecommunication service provider using an item identifier of the one or more item identifiers.

5. The method of claim 4, comprising:
receiving, via the interface panel, plan information for a service plan, wherein performing the activation process comprises associating at least one of the device or the item identifier with the service plan.

6. The method of claim 1, wherein:
the item comprises a device equipped with at least one of a Subscriber Identity Module (SIM) card or an embedded SIM (eSIM); and
the one or more item identifiers comprise at least one of an Integrated Circuit Card Identifier (ICCID) or an Embedded Universal Integrated Circuit Card (eUICC) Identifier (EID) associated with at least one of the SIM card or the eSIM.

7. The method of claim 1, wherein:
capturing the image is performed during the item retrieval process.

8. The method of claim 7, wherein determining the one or more item identifiers comprises:
analyzing the image to identify a visual code on the item; and
determining the one or more item identifiers based upon the visual code.

9. The method of claim 1, wherein:
the image has a view of the item and a second item;
the method comprises:
cropping the image to generate a cropped image excluding at least a portion of the second item;
analyzing the cropped image to identify a visual code on the item; and
determining the one or more item identifiers based upon the visual code.

10. The method of claim 1, comprising:
engaging a door to the dispensing location to allow access to the item at the dispensing location.

11. A computer comprising:
a processor coupled to memory, the processor configured to execute instructions from the memory to perform operations comprising:
receiving a selection of an item via an interface panel of a vending machine, wherein:
the vending machine comprises a storage system with a plurality of storage locations; and
the item is stored in a storage location of the plurality of storage locations;
performing, using a hopper of the vending machine, an item retrieval process to collect the item from the storage location and transfer the item to a dispensing location;
capturing an image of the item using a camera coupled to the hopper;
determining one or more item identifiers associated with the item based upon the image; and
performing an activation process for the item based upon the one or more item identifiers.

12. The computer of claim 11, the operations comprising:
analyzing the image to identify a visual code on the item; and
determining the one or more item identifiers based upon the visual code.

13. The computer of claim 12, wherein the one or more item identifiers comprise at least one of:
an International Mobile Equipment Identity (IMEI) associated with the item;
an Integrated Circuit Card Identifier (ICCID) associated with the item;
an Embedded Universal Integrated Circuit Card (eUICC) Identifier (EID) associated with the item;
a stock-keeping unit (SKU) associated with the item; or
a vendor identifier associated with the item.

14. The computer of claim 11, wherein performing the activation process comprises:
registering a device of the item with a telecommunication service provider using an item identifier of the one or more item identifiers.

15. The computer of claim 14, the operations comprising:
receiving, via the interface panel, plan information for a service plan, wherein performing the activation process comprises associating at least one of the device or the item identifier with the service plan.

16. The computer of claim 11, wherein:
the item comprises a device equipped with at least one of a Subscriber Identity Module (SIM) card or an embedded SIM (eSIM); and
the one or more item identifiers comprise an Integrated Circuit Card Identifier (ICCID) associated with at least one of the SIM card or the eSIM.

17. The computer of claim 11, wherein:
capturing the image is performed during the item retrieval process.

18. The computer of claim 11, wherein determining the one or more item identifiers comprises:
analyzing the image to identify a visual code on the item; and
determining the one or more item identifiers based upon the visual code.

19. A non-transitory computer-readable medium storing instructions that when executed perform operations, the operations comprising:
receiving a selection of an item stored in a vending machine;
performing an item retrieval process to collect the item from a storage location of the vending machine and transfer the item to a dispensing location;
capturing an image of the item during the item retrieval process;
determining one or more item identifiers associated with the item based upon the image; and
performing an activation process for the item based upon the one or more item identifiers.

20. The non-transitory computer-readable medium of claim 19, the operations comprising:
analyzing the image to identify a visual code on the item; and
determining the one or more item identifiers based upon the visual code.
